(19) United States
(12) Patent Application Publication
(10) Pub. No.: US 2002/0095274 A1
(43) Pub. Date: Jul. 18, 2002

(54) Pool cover design verifying system

(76) Inventors: Alfred N. Richards, Chester Springs, PA (US); Fred Hansen, Wayne, PA (US)

Correspondence Address: Alfred N. Richards, 62 Fairfield Lane, Chester Springs, PA, 19355, US

(21) Appl. No.: 09/761,065

(22) Filed: Jan. 17, 2001

(51) Int. Cl. G06F 17/50

(52) U.S. Cl. 703/1

(57) ABSTRACT

A pool cover design verifying system which produces a graphical image of the pool at the vicinity of the pool as the measurements are being taken on the pool. This enables the pool measurers to be alerted to errors in measurement at the time the measurements are being taken and before a pool cover is improperly fabricated. Further, check measurements may be taken of the pool and entered into the portable computer at the pool where a comparative calculation may be made between the two sets of measurements. In this manner, if there is a difference between the check measurements and the measurements calculated by the portable computer an error, alert or other signal may be generated, enabling the pool measurers the ability to check and correct the measurements before they leave the pool location. The system provides other advantages of inputting and keeping track of the status of orders for pool covers and providing status reports on demand.

### FIELD OF THE INVENTION

The invention consists of a swimming pool cover design verifying system which includes custom designed computer software and a portable computer or hand held electronic device.

### BACKGROUND OF THE INVENTION

Swimming pool design has become more elaborate and more specific to the homeowners desire to beautify a backyard landscape. Design elements include attached or raised spas, waterfalls, diving rocks and other natural and manmade materials and structures used to create a unique setting. Swimming pool service companies are challenged to design and supply custom pool covers that will not only cover and protect the swimming pool during the off season but will also conform to ASTM standards for a safety cover.

The layout and design of a pool cover involves detailed measurements using a triangulation method familiar to most swimming pool professionals. The manual method of triangulating measurements does not include any checks for accuracy and can result in the manufacturer making a cover that does not fit the pool. The net result can be a remeasure and remake at significant expense to the swimming pool company.

The invention solves this problem by providing a way to verify all measurements prior to submittal to the manufacturer. It also provides other advantages for this design and order/entry process.

### SUMMARY OF THE INVENTION

A system is utilized to enter and verify measurements when taken for the purpose of designing a pool cover for a manufacturer. This system includes application software, a central or host computer and either a laptop or portable computer.

Specifically, a portable computer i.e. a laptop or hand held computer with the software installed is taken to the pool. The method of measuring the pool through triangulation is employed with the measurements being entered directly into the computer. Additional measurements are entered in the computer and electronically go through a verification process to determine the accuracy of the triangulated set of measurements. Any discrepancies in the measuring process trigger an alarm so corrections can be made prior to leaving the job site.

The overall system starts with a host or office computer where a data base is built from prospective pool cover clients. This data includes name, address, date, and type of cover order or quotation requested. The host system has the ability to track orders from initial contact through installation, generate order forms and quotations based on field data and store all active and inactive records.

Once the initial client data is established file records can be downloaded to portable computers i.e. laptops for field measurement. The field systems do not include complete set of programs found on the host computer nor is it operable without field software. It allows the downloaded file to be modified in the field while a locked record of the same file is retained in the host computer. This host record cannot be opened until the field record is returned.

The actual measuring methods are the same as in a manual system however the data is organized in such a fashion as to create a graphical display of the pool based on the input and then verified with an additional set of measurements called check measurements. The method for measuring is triangulation where two coordinates called point A and point B are established outside the pool perimeter. The entire pool perimeter at the waters edge is numbered in prescribed increments. Measurements are then taken from point A and point B to the perimeter numbers around the pool. As these two sets of numbers are entered in the computer the pool shape appears graphically on the computer screen. Incorrect measurements will generate a warning message from the computer. In addition to that the graphical representation of the pool will alert the technician to any discrepancies.

The next set of measurements that are taken are check measurements. These are usually a length and three widths that are taken from a numbered perimeter point to a corresponding point on the opposite side of the pool. When entered in the computer these distances are compared to the triangulated set of data previously entered. If the measurement is outside the programmed tolerance of the algorithmically generated length a warning will alert the operator.

Other obstructions and other design features (e.g. gardens, waterfalls ) can then be positioned using the established numbering system and transferred to the graphical display. This building process will provide the manufacturer with a more relevant set of instructions with which to build the cover.

The completed field data can then be saved on a backup diskette for transfer back to the host computer. Upon uploading the completed record the office system file is then unlocked for review. At this point a quotation can be generated or a completed order form can be printed out in the desired manufacturers format. The customer data base can also be updated to reflect that contacts position in the ordering process i.e. 1)contacted, 2)quoted, 3)measured, 4)ordered, 5)received, and 6)installed. Management reports can be generated for further action.

The field process of entering data can also use voice recognition software with voice recorders. Transfer of data is then accomplished with the IR port on a portable computer i.e. laptop or hand held computer.

### BRIEF DESCRIPTION OF THE DRAWINGS

For the purpose of illustrating the invention the shown drawings referr to the computer generated screens, graphics, and forms generated by the software. A flow chart presents the order in which the system is used.

FIG. 1 represents a pool laid out for measuring showing AB points outside the perimeter of the pool and a numbered sequence arround the pool perimeter at waters edge. This is the first step that a technician must take prior to field measuring.

FIG. 2 shows the different elements of the system including a laptop computer (4), a host or office computer (3), a hand held computer (5), and a portable micro recorder (6).

FIGS. 3 to 9 are printouts of the computer screens which show the data entry fields to be completed for the measuring and verification process.

FIGS. 10 to 12 are flow charts and diagrams showing hardware relationships and the process of the invention.

FIGS. 13 and 14 are the resulting quotation and manufacturers order forms generated to complete the process.

### DETAILED DESCRIPTION OF THE INVENTION

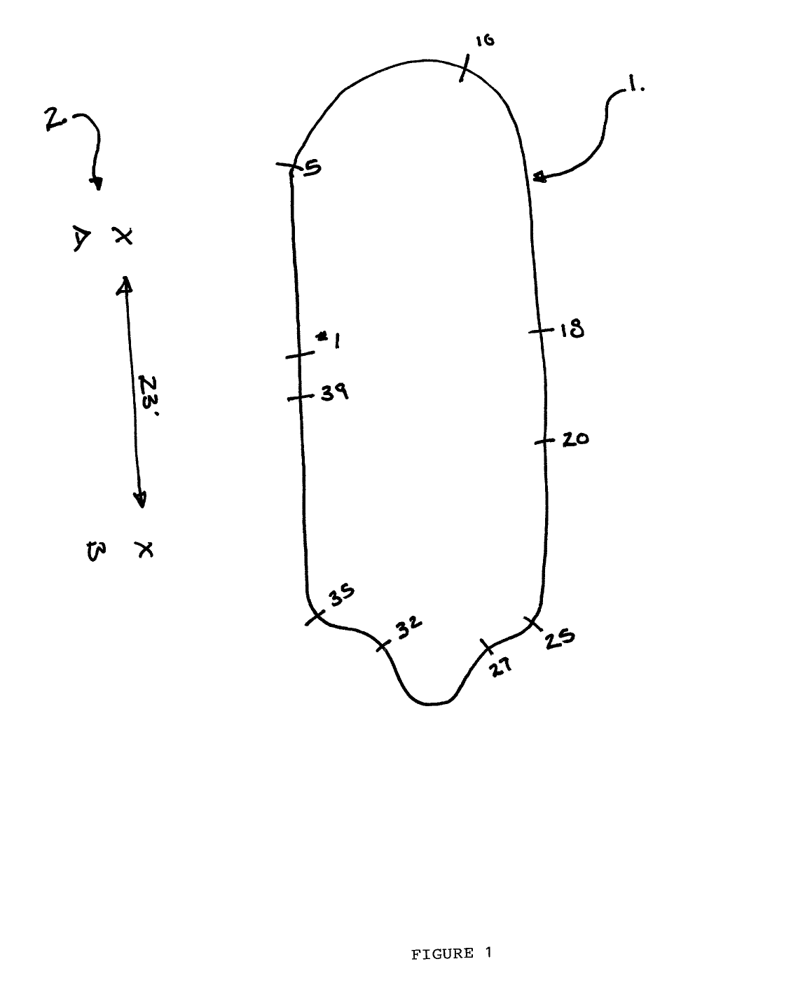

There is shown in FIG. 1 an oval shaped pool (1) with a walkout at one end. The pool has been numbered around the perimeter with numbering sequence going from 1 to 39 in a clockwise rotation. On one side of the pool two points have been established called point A and point B (2) where point A is on the left facing the pool. A distance of at least 10′ is established between point A and point B. FIG. 1 has an A-B coordinate distance of 23′. This is the physical layout of the pool that a technician must make prior to taking measurements.

A method of triangulation is employed where a tape measure is used to measure the distance from point A to peripheral points 1 to 39; and then, from point B to peripheral points 1 to 39. In a manual system of triangulation a compass would draw arcs—to scale—using the measurements provided. The intersection of these arcs would represent the perimeter points as established around the pool.

In a manual system these measurements are gathered and then sent to a pool cover manufacturer for layout. There is no way for the technician to verify the accuracy of these measurements at the job site.

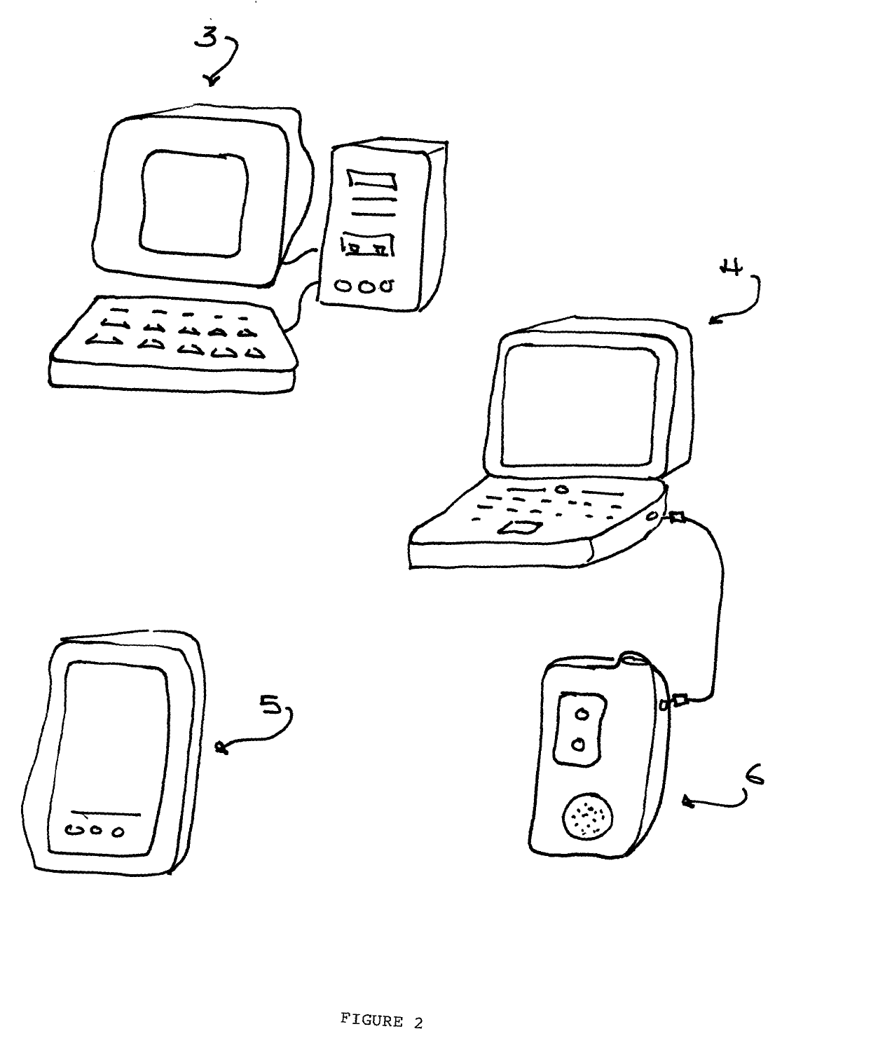

FIG. 2 represents the hardware used to employ the software invention. This includes (3) a host or office computer, (4) a portable or laptop computer, (5) a hand held computer, (6) a micro recorder for voice recognition.

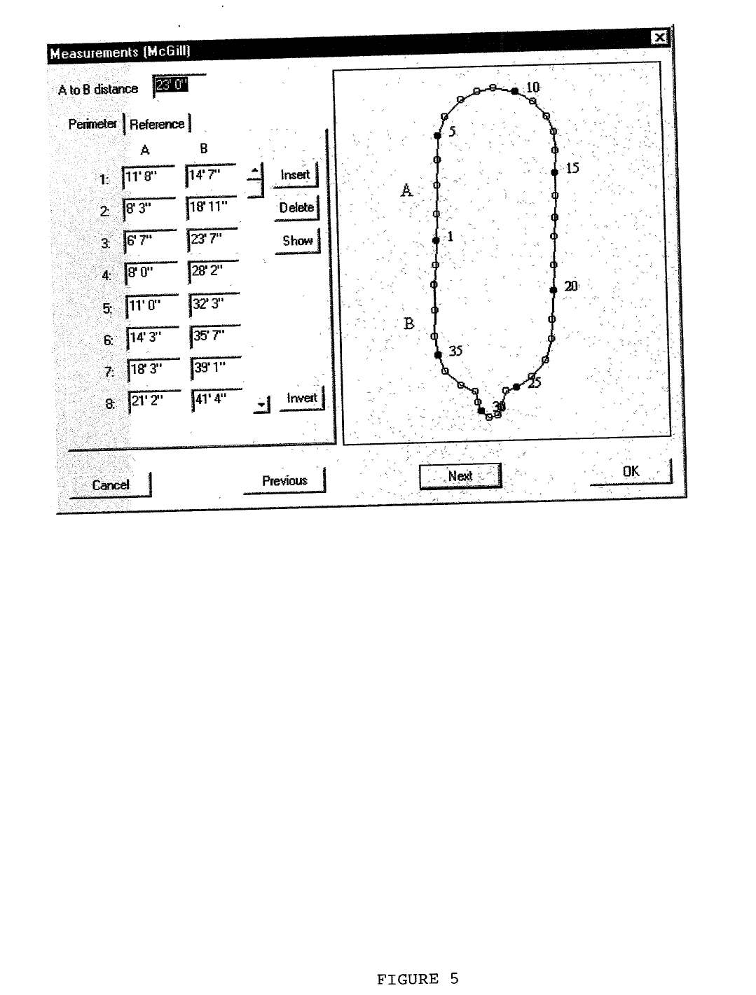

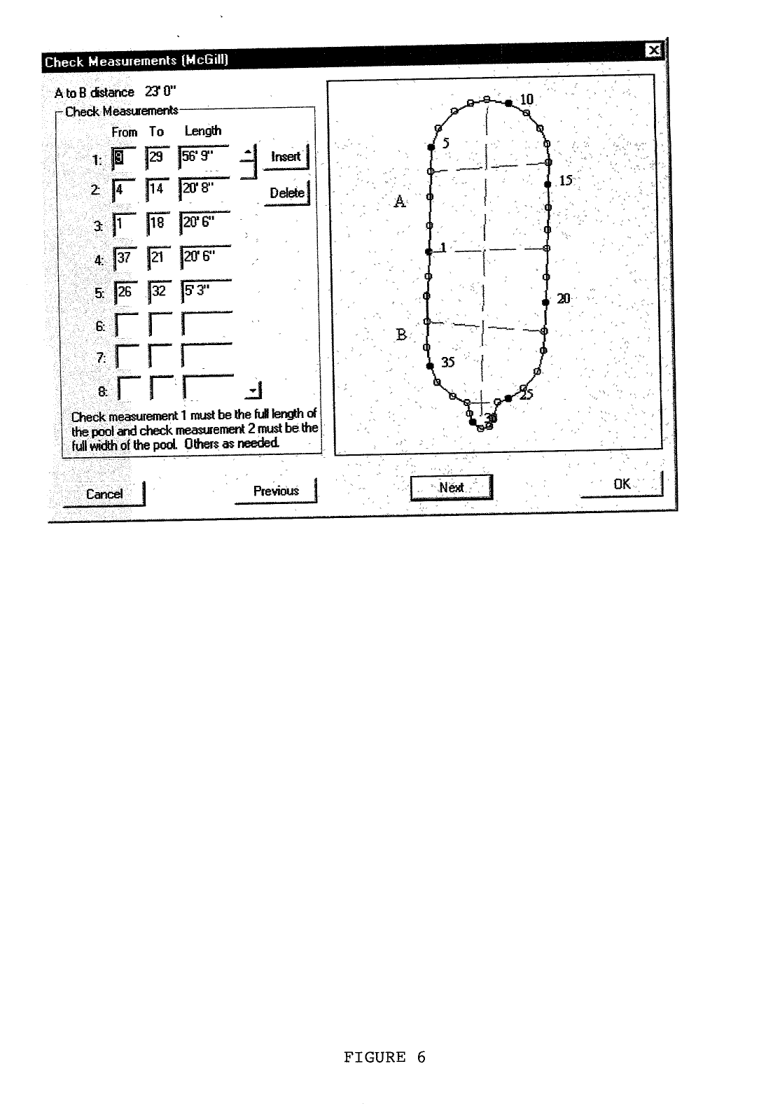

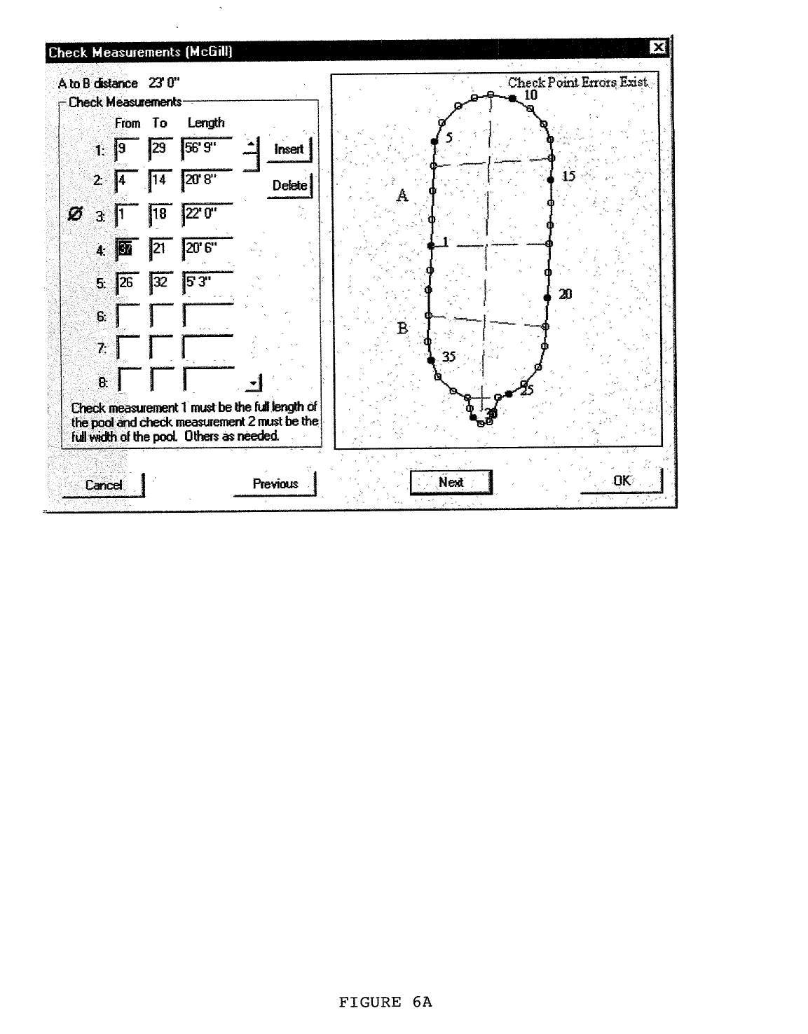

The initial data base of customer name, address, phone number and contact dates are entered into the host computer (3) first and then downloaded to a laptop computer (4) or a hand held computer (5) for field use. At pool side measurements as described in FIG. 1 are entered into a micro recorder (6) for voice recognition or into a palmcorder (5) or a laptop computer (6) to process the data. This data can then be verified in the field through a graphical representation as displayed on the computer screen (FIG. 5) or through check measurements (FIG. 6).

The downloaded file used in the field can then be uploaded back into the host computer upon return to the office or home base. At that time a quotation (FIG. 13) can be generated based on accurate field data and/or an order form (FIG. 14) can be generated and then sent to a manufacturer.

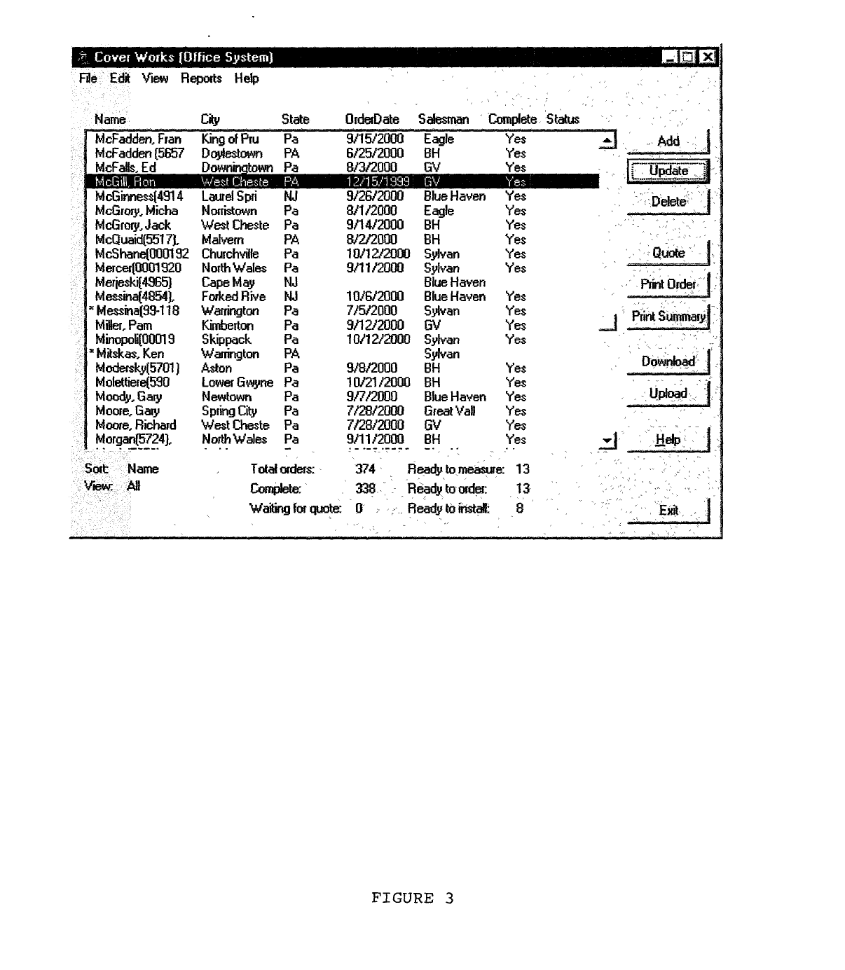

FIG. 3 represents the Office System screen showing the file(s) entered with names,address, dates, status and summary totals. This is the main program screen from which all entries are made.

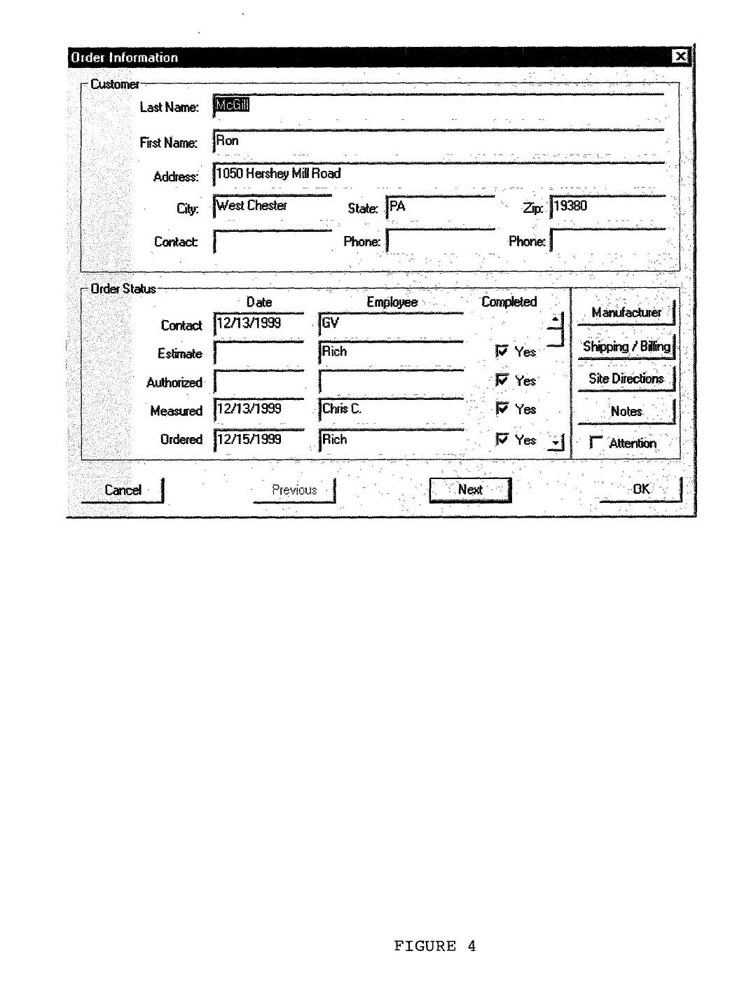

FIG. 4 is the initial contact screen used to enter customer information and contact through order status.

Field measurements are entered into the screen as shown in FIG. 5. These measurements include an A and a B coordinate point and the actual measurements to points located around the pool periphery (as illustrated in FIG. 1). As the points are entered a graphical image of the pool appears on the computer screen as generated by the program algorithms . If during this process the image of the pool does not look correct the technician has the opportunity to remeasure and make corrections as required.

FIG. 6 represents the next input screen (titled Check Measurements) in the process. Physical measurements are taken between corresponding points along the periphery of the pool and entered as check points. For example, the physical measurement between point 1 and point 18 is shown as 20′ 6″. When entered a green line will appear on the screen if the measurement is within the correct tolerances of the algorithm. If incorrect a red line will appear with a warning symbol next to the measurement (see FIG. 6a). These additional measurements, called check measurements, compare the triangulated results to isolated physical measurements. Once again, if the measurements do not correspond the technician has the opportunity to remeasure before leaving the field and possibly entering an incorrect set of data with the manufacturer.

Additionally, the computer can provide the measurement between 2 points as algorithmically generated by the triangulated method (FIG. 5). By entering a 999 code in the “Length” field of FIG. 6 computer generated length will be given for comparison to an actual physical measurement. While not the preferred method it can be used for reference if incorrect measurements persist.

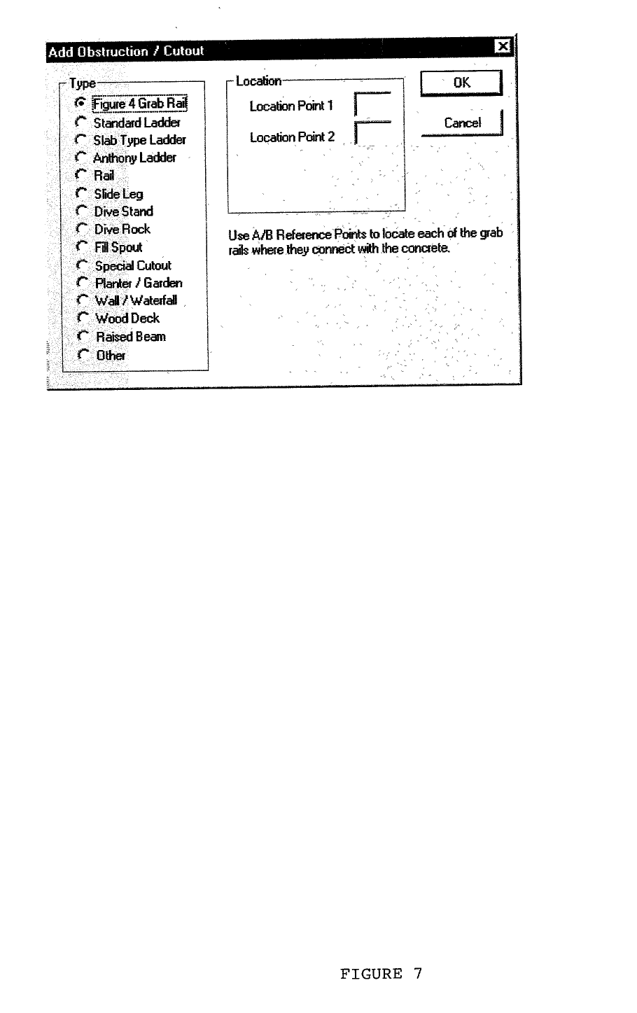

FIG. 7 is next entry screen for inputting obstructions that may affect the way in which the cover is made. The type of obstruction is selected and then located by referencing the relating points around the pool periphery.

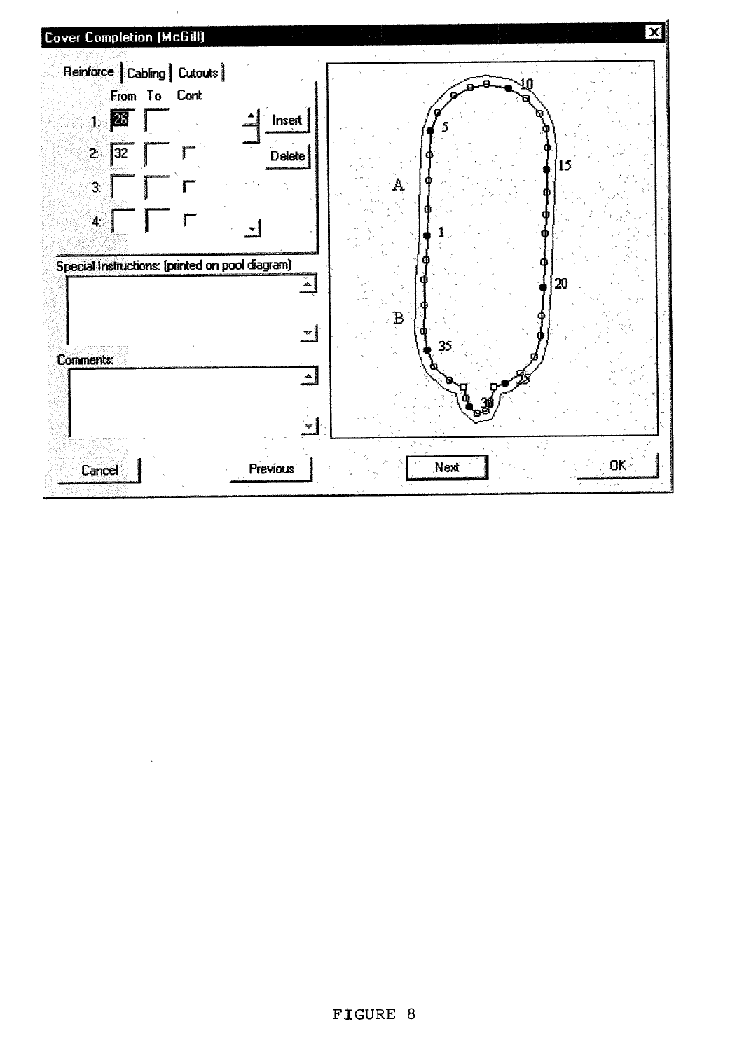

FIG. 8 is the completion screen for entering special construction considerations such as reinforcing, cutouts and cabling. These considerations are also referenced to peripheral points as established and verified in FIGS. 5 & 6.

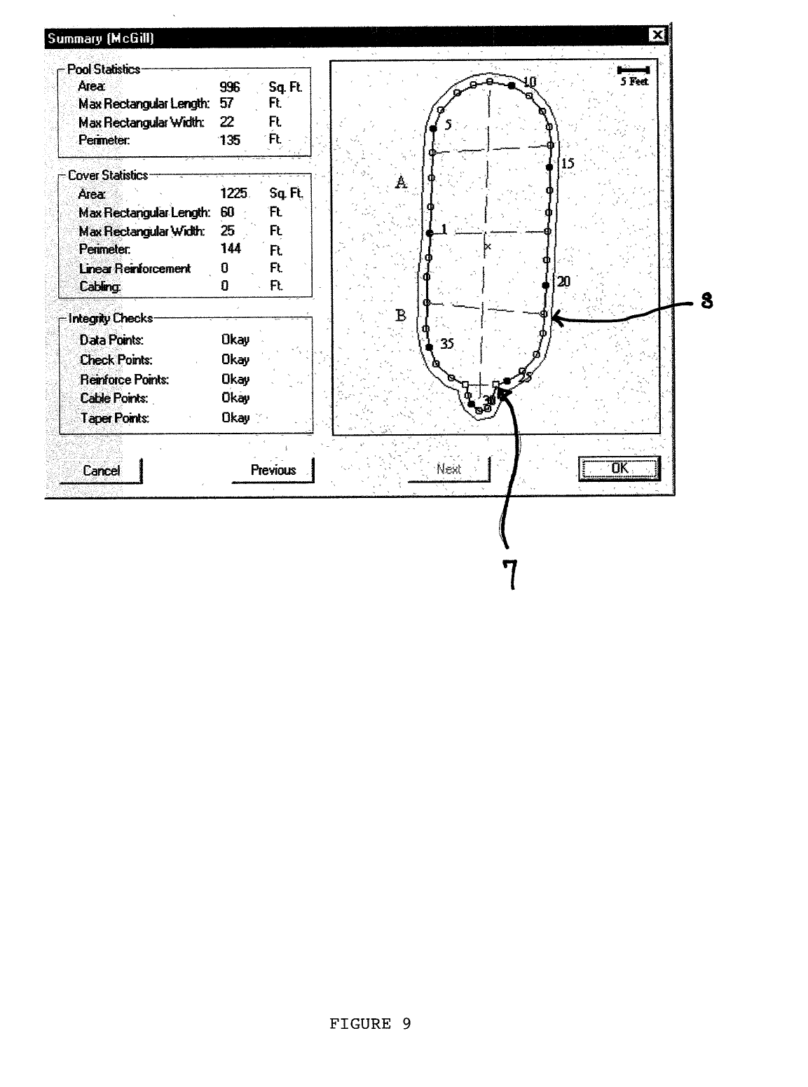

FIG. 9 is a summary screen showing graphical output of the pool's shape with design considerations such as reinforcing points (7) and overlap (8). It also lists statistical information an the pool and cover and it lists the integrity checks.

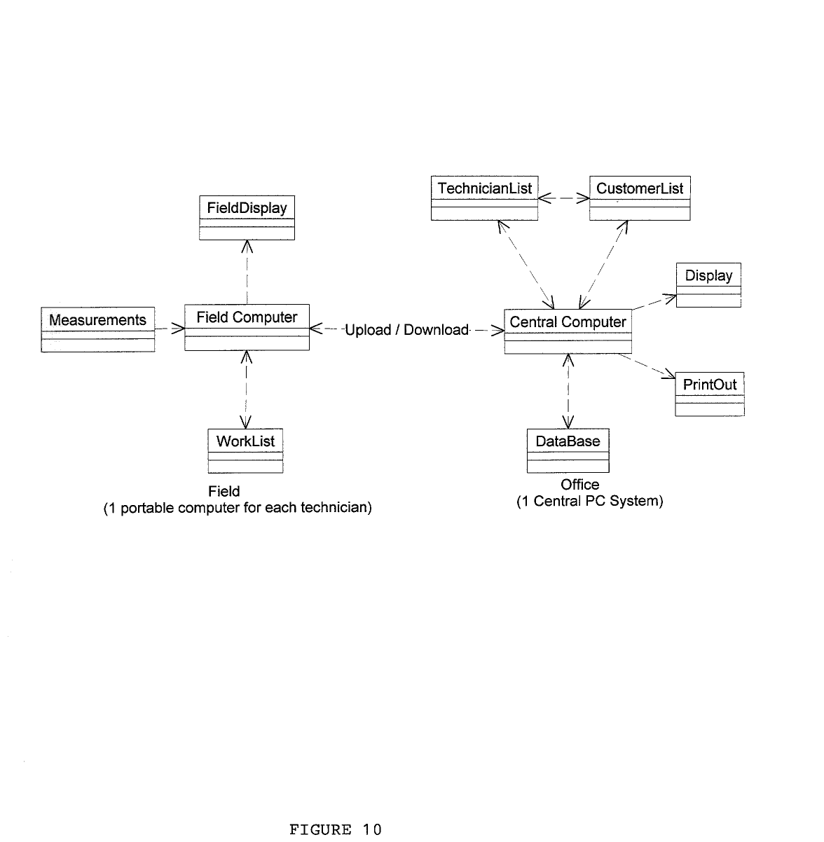

FIG. 10 is a block diagram which demonstrates the relationship of the host computer to the field computer and the input and output of information between the office system and the field system.

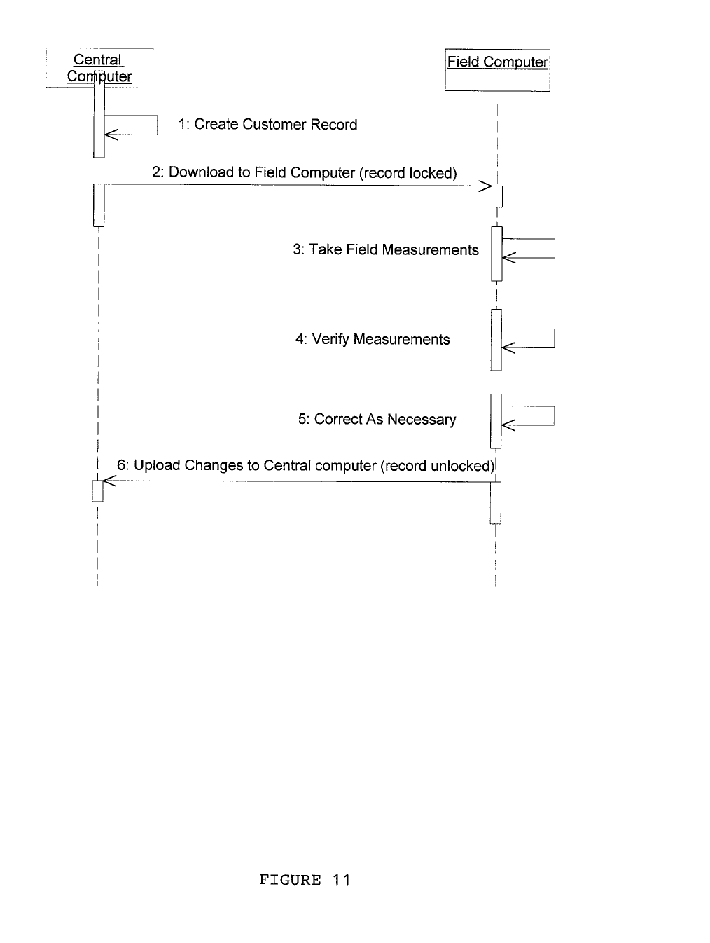

FIG. 11 provides a flow chart detailing the process of the invention. A host or central computer is established with the software loaded in the computer. A software CD is required to run the program. Step I occurs with the initial entry of customer information. A customer record or file is then established which may contain name, address, contact date, type of cover requested as well as any other customer requests or requirements. Step 2 is to download the established customer(s) file to a portable computer. At this time the record on the host computer is locked and cannot be opened. Step 3 is to take field measurements and entering them into the field computer. Steps 4 and 5 are to take verifying measurements and correct if necessary. These corrections will be apparent from both the graphical image and/or the check measurement error signal. Other design considerations can be made at this time using the verified and corrected measurements as reference. Step 6 is to upload the amended customer file back to the host computer. The record in the host computer will be automatically unlocked during this process.

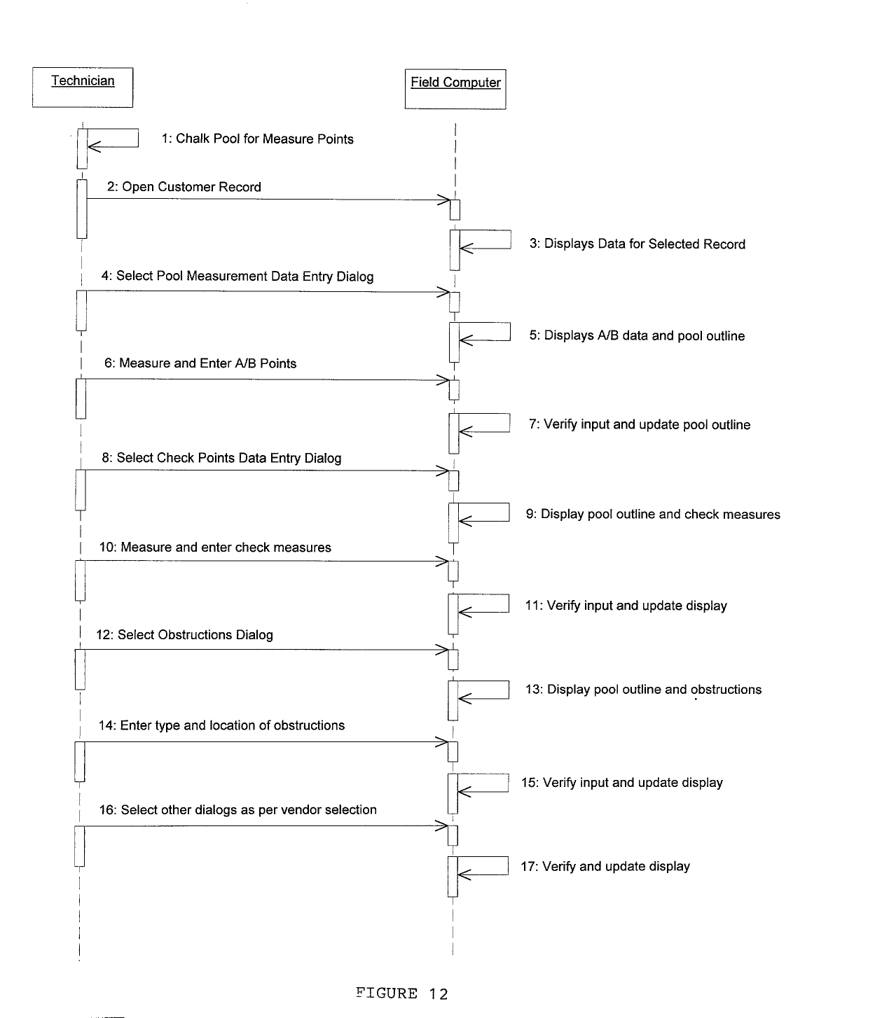

FIG. 12 is a flow chart showing the process as it refers to the technicians physical process in measuring a pool and employing the invention. Step 1 is for the technician to chalk the pool perimeter points and to establish the AB coordinates. Step 2 is for the technician to open the corresponding record or file on the portable computer. Step 3 occurs when the portable computer displays the current information on that customer and opens a series of dialogue boxes. Step 4 is for the pool technician selects the specific dialogue box for AB measurements. Step 5 occurs when the portable computer displays the appropriate screen and dialogue boxes for AB input. Step 6 is to take physical measurements from AB coordinates to peripheral points around the pool and enter them in the computer. Step 7 includes the emerging graphic of the pool on the computer screen and any resulting error messages to indicate an incorrect measurement based on the triangulation algorithm. Steps 8 to 11 are the process of selecting, measuring and entering check measurements to verify the triangulation measurements from coordinates A and B. Correct measurements will be graphically displayed with a green dashed line between the select points. An incorrect measurement will appear as a red dashed line with an error symbol. Step 12 allows the technician the ability to enter any obstructions that may affect the design of the cover by selecting the obstructions dialogue box(es). Steps 13 and 14 occurs as the technician enters the type and location (by referenced AB points) of obstructions. Graphical output displays the obstruction in relation to the outline of the pool and cover overlap. Step 15 occurs as the technician verifies the display and enters additional obstructions. Steps 16 and 17 continue the process of entering additional design considerations and verifying the resulting graphic. Representational lines and symbols such as squares for reinforcing patches, black for cables and so on will appear in the graphic as checked to the coordinates given.

FIG. 13 is a printout of a quotation which is based on the calculations established in the measuring process of the invention.

FIG. 14 is the data printed out in the selected manufacturers' format providing the true and verified measurements and other pertinent instructions used in constructing the pool cover.

The present invention may be found in other defined forms without departing from the spirit or essential attributes of the invention. Therefor reference should be made to the appended claims as indicating the scope of the invention.

We claim:

1. A system comprising: A portable computer which may be transported to a pool location; means for inputting a plurality of A/B triangulation measurements from a first coordinate A and a second coordinate B to a series of points established on the periphery of the pool, and a given measurement between points A and B entered into the computer. Upon entering this set of data the computer will produce a graphical representation of the pool outline which may be verified.

2. A system in accordance with claim 1 including:
a host computer located at a central location;
means for inputting data into said host computer relating to said pool and a request for a pool and a request for a pool cover relating to said pool;
means for transferring data from said host computer to said portable computer; and, means for transferring data from said portable computer to said host computer upon completion and verification of inputted A/B triangulated measured data of said pool.

3. A system in accordance with claim 1, including;
means for inputting check measurement data in the form of a distance between said selected points of said pool periphery; and
wherein said portable computer is provided with a means for calculating the distance between said selected points based upon inputted A/B triangulation data.

4. A system in accordance with claim 1 wherein said measurement data may be inputted into said computer via voice recognition circuitry.

5. A system in accordance with claim 1 wherein said data may be inputted into said portable computer by inputting said data into a hand held computer and subsequently, transferring said data from said hand held computer to said portable computer.

6. A system in accordance with claim 3 wherein said portable computer includes the means for comparing the inputted check measurement of said pool and the corresponding calculated measurement by A/B triangulation and generate an error signal when a discrepancy exceeds a predetermined amount.

7. A system in accordance with claim 1 wherein said portable computer includes means for calculating the surface area of a pool and the area of a cover to cover said pool.

8. A system in accordance with claim 1 wherein said computer includes means for calculating the length of the perimeter of said pool.

9. A system in accordance with claim 1 wherein said portable computer includes a means for locating and identifying pool features and other obstructions in relation to the computer verified measurements and resulting graphical layout.

10. A system in accordance with claim 2 wherein said host computer means for storing data relating to each pool and the status of an order for a pool cover for said pool.

11. A system in accordance with claim 1 wherein said portable computer includes means for specifying cover construction requirements to satisfy identified pool features and other cover obstructions.
The present invention may be found in other defined forms without departing from the spirit or essential attributes of the invention. Therefor reference should be made to the appended claims as indicating the scope of the invention.
